(19) United States
(12) Patent Application Publication
(10) Pub. No.: US 2026/0365495 A1
(43) Pub. Date: Nov. 19, 2026

(54) MOBILE CRANE AND METHOD FOR OPERATING A MOBILE CRANE

(71) Applicant: Liebherr-Werk Ehingen GmbH, Ehingen (DE)

(72) Inventors: Michael ENGST, Ehingen (DE); Ulrich WIEDEMANN, Ehingen (DE)

(21) Appl. No.: 19/676,569

(22) Filed: May 13, 2026

(30) Foreign Application Priority Data
May 13, 2025 (DE) 10 2025 118 359.7

(51) Int. Cl. B66C 13/14; B66C 23/40

(52) U.S. Cl. CPC B66C 13/14; B66C 23/40

(57) ABSTRACT

The present disclosure relates to a mobile crane with a traveling undercarriage, a superstructure arranged rotatably on the undercarriage, and a drive system with a first pump splitter gearbox and a second pump splitter gearbox, wherein the drive system has an internal combustion engine, in particular a diesel engine, and/or an electric machine, each of which is mechanically connected to the first pump splitter gearbox, an electric motor, which is mechanically connected to the second pump splitter gearbox, and a high-voltage battery, which is electrically connected via an intermediate circuit to the electric machine and/or the electric motor.

### CROSS-REFERENCE TO RELATED APPLICATION

The present application claims priority to German Patent Application No. 10 2025 118 359.7 filed on May 13, 2025. The entire contents of the above-listed application are hereby incorporated by reference for all purposes.

### TECHNICAL FIELD

The present disclosure relates to a mobile crane with a traveling undercarriage, a superstructure arranged rotatably on the undercarriage, and a drive system with a first pump splitter gearbox and a second pump splitter gearbox.

### BACKGROUND

Particularly in the case of mobile cranes in the form of large crawler cranes, according to the prior art two internal combustion engines in the form of diesel engines are installed, each of which can drive several, for example two, pumps via a pump splitter gearbox.

### SUMMARY

The construction of such a mobile crane is shown in FIG. 4. The mobile crane has two internal combustion engines 7, for example in the form of diesel engines, each internal combustion engine 7 being connected to a pump splitter gearbox 12 and being able to drive the latter, each pump splitter gearbox 12 having two pumps 15, for example in the form of hydraulic pumps.

In each case, one pump 15 of one pump splitter gearbox 12 is hydraulically combined with one pump 15 of the other pump splitter gearbox 12 with a crane mechanism, so that the mechanism, for example a winch W, can be driven optionally by one of the internal combustion engines 7 or one pump 15 driven by the respective internal combustion engine 7, or by both internal combustion engines 7 or two pumps 15 which can each be driven by one of the internal combustion engines 7.

This is illustrated diagrammatically in FIG. 5. Each internal combustion engine 7 can drive two pumps 15. Pumps 15 assigned to two different internal combustion engines 7 are hydraulically connected to one of the two winches W in such a way that the respective winch W can be driven either by one of said pumps 15 or by both of said pumps 15. For example, either the internal combustion engine 7 arranged above in FIG. 5 can drive the winch W shown on the left in FIG. 5 via its pump 15 shown on the left in FIG. 5, or both internal combustion engines 7, each with the pumps 15 shown on the left in FIG. 5, can drive the winch W shown on the left in FIG. 5. The same applies analogously for the two pumps 15 shown on the right and the winch W shown on the right in FIG. 5.

By means of such a redundant construction, it is ensured that the mobile crane can continue to be operated even in the event of failure of one internal combustion engine 7 or one pump splitter gearbox 12 or one pump 15.

Furthermore, drag torques and losses are thus reduced, since at low required powers it is only necessary to drive one internal combustion engine 7 and one pump splitter gearbox 12 including pumps 15.

If a high power or a large volume flow is required, wherein at a large volume flow and low pressure the power is not high, the mobile crane can also be operated with both internal combustion engines 7.

When the internal combustion engines 7 are at a standstill, air conditioning of the crane cab is realized via an additional small internal combustion engine 70, for example in the form of a small diesel engine, which can drive a generator 10 which can supply the air-conditioning compressor 1000 with electrical power, for example with a voltage of 230 V, and heating of the crane cab takes place, for example, via an auxiliary combustion heater.

The pumps 15 are used to drive the various mechanisms of the mobile crane, for example in the form of winches and auxiliary loads. In the case of regenerative power, for example when lowering a load, the energy is converted into heat via a hydraulic brake pump, which has a hydraulic pump and a pressure relief valve, or the engine brake. In particular when the regenerative power is dissipated in a hydraulic brake pump, it is necessary to dissipate the resulting hydraulic oil heat in a complex manner via a cooler.

Operation of, in particular, large internal combustion engines leads to exhaust emissions and noise emissions.

Against this background, the present disclosure is based on the object of improving a construction of the above-mentioned mobile crane, in particular with regard to a reduction or elimination of exhaust emissions and/or noise emissions.

This object is achieved by the subject matter as described herein.

Accordingly, it is provided that the drive system has an internal combustion engine, in particular a diesel engine, and/or an electric machine, each of which is mechanically connected to the first pump splitter gearbox, an electric motor, which is mechanically connected to the second pump splitter gearbox, and a high-voltage battery, which is electrically connected via an intermediate circuit to the electric machine and/or the electric motor.

Optionally, a mechanical or electrical connection may exist directly, wherein the connected elements directly adjoin one another and are connected, or indirectly, wherein the connected elements are mechanically or electrically connected to one another via other elements, such as mechanical shafts, gearboxes or cables.

Mechanical power can optionally be transmitted between the connected elements via a mechanical connection, and electrical power can optionally be transmitted between the connected elements via an electrical connection.

The electric machine is optionally a high-voltage generator/electric motor. The electric motor is optionally a high-voltage electric motor.

It is conceivable that the superstructure has an energy generation unit electrically connected to the intermediate circuit, for example in the form of a fuel cell.

It is optionally provided that the drive system has a distribution gearbox, wherein the internal combustion engine, the electric machine and the first pump splitter gearbox are mechanically connected to the distribution gearbox in such a way that the internal combustion engine can drive the electric machine and/or the first pump splitter gearbox via the distribution gearbox and/or the electric machine can drive the internal combustion engine and/or the first pump splitter gearbox via the distribution gearbox and/or the first pump splitter gearbox can drive the electric machine via the distribution gearbox.

It is optionally provided that the internal combustion engine is mechanically connected to the distribution gearbox via a clutch, so that the driving connection between the internal combustion engine and the distribution gearbox can be disconnected or established by the clutch.

It is optionally provided that the distribution gearbox is mechanically connected to the first pump splitter gearbox via a clutch, so that the driving connection between the distribution gearbox and the first pump splitter gearbox can be disconnected or established by the clutch.

It is optionally provided that the distribution gearbox is mechanically connected to the first pump splitter gearbox via a cardan shaft and/or that the electric motor is mechanically connected to the second pump splitter gearbox via a cardan shaft.

It is optionally provided that each pump splitter gearbox has two pumps, in particular hydraulic pumps, wherein a first pump of the first pump splitter gearbox and a first pump of the second pump splitter gearbox are designed and arranged for driving a crane mechanism, in particular a winch, of the mobile crane, wherein a second pump of the first pump splitter gearbox and a second pump of the second pump splitter gearbox are designed and arranged for driving a further crane mechanism, in particular a further winch, of the mobile crane.

It is optionally provided that the undercarriage has an electrical network with a grid connection for supplying the electrical network of the undercarriage with electrical power from an external power grid, and the superstructure has the intermediate circuit and an electrical network electrically connected to the intermediate circuit, in particular via a converter, optionally a rectifier, wherein a slewing ring with a slip-ring transmitter is arranged between the undercarriage and the superstructure, which is designed to transmit electrical power from the electrical network of the undercarriage into the electrical network of the superstructure.

It is optionally provided that the superstructure has the high-voltage battery and the electric motor and furthermore, each electrically connected to the intermediate circuit, a heat pump, a high-voltage heater, a high-voltage air-conditioning compressor, an inverter, in particular for providing a 230 V supply, for example an electrical supply of an air-conditioning system of the mobile crane, a DC-DC converter for connecting a low-voltage on-board electrical system with a vehicle battery to the intermediate circuit and/or one or more converters, optionally inverters, in particular in each case for the electrical supply of the electric motor and/or of the electric machine.

It is optionally provided that the superstructure has all electrical main consumers of the mobile crane.

It is optionally provided that all electrical main consumers of the mobile crane are arranged in the superstructure.

It is optionally provided that the mobile crane is a crawler crane, in particular a lattice-boom crawler crane, or a lattice-boom mobile crane.

The mobile crane optionally has a load capacity of more than 100, 400, 800, 1000 or 2IN THE CLAIMSons.

The mobile crane is optionally a hybrid crawler crane.

The mobile crane is optionally a large crawler crane which can work on a construction site with no exhaust emissions or with reduced exhaust emissions and/or noise emissions.

The disclosure also relates to a method for operating a mobile crane, in particular a mobile crane according to the disclosure, wherein the internal combustion engine is operated and drives the first pump splitter gearbox and/or the electric machine and/or wherein the electric machine is operated and drives the first pump splitter gearbox and/or the internal combustion engine and/or wherein the first pump splitter gearbox is operated and drives the electric machine and/or wherein the electric motor drives the second pump splitter gearbox.

It is optionally provided that the high-voltage battery is charged, when the electric machine is driven by the internal combustion engine and/or by the pump splitter gearbox, by electrical power generated by the electric machine and/or that the high-voltage battery is charged by electrical power provided by a power grid.

It is optionally provided that charging of the high-voltage battery is ended when a defined state of charge of the high-voltage battery is reached, the internal combustion engine is switched off, and the first pump splitter gearbox is driven by the electric machine and/or the second pump splitter gearbox is driven by the electric motor.

It is optionally provided that the high-voltage battery is charged in operating phases with low power requirements and that the high-voltage battery is discharged in operating phases with high power requirements.

It is optionally provided that the internal combustion engine is started by the electric machine.

With the present disclosure, on the basis of the concept known from the prior art with two pump splitter gearboxes, a mobile crane can be operated both by electric motor and by internal combustion engine without power restrictions. Furthermore, the internal combustion engine can be designed smaller than the internal combustion engines according to the prior art. Both in internal-combustion-engine operation and in electric-motor operation of the mobile crane, the solution according to the disclosure optionally leads to a reduction of the exhaust emissions and/or noise emissions of the mobile crane.

At this point it is pointed out that the terms “a” and “an” do not necessarily refer to exactly one of the elements, although this represents one possible embodiment, but may also denote a plurality of the elements. Likewise, the use of the plural also includes the presence of the element in question in the singular, and conversely the singular also includes several of the elements in question. Furthermore, all features of the disclosure described herein can be claimed in any desired combination with one another or isolated from one another.

### BRIEF DESCRIPTION OF THE FIGURES

Further advantages, features and effects of the present disclosure result from the following description of preferred exemplary embodiments with reference to the figures, in which identical or similar components are designated by the same reference numerals. Here, the following are shown:

FIG. 1: a schematic block diagram of an embodiment of a mobile crane according to the disclosure.

FIG. 2: a schematic block diagram of an embodiment of a mobile crane according to the disclosure.

FIG. 3: a side view of an embodiment of a mobile crane according to the disclosure.

FIG. 4: a schematic block diagram of an embodiment of a mobile crane according to the prior art.

FIG. 5: a schematic block diagram of an embodiment of a mobile crane according to the prior art.

### DETAILED DESCRIPTION

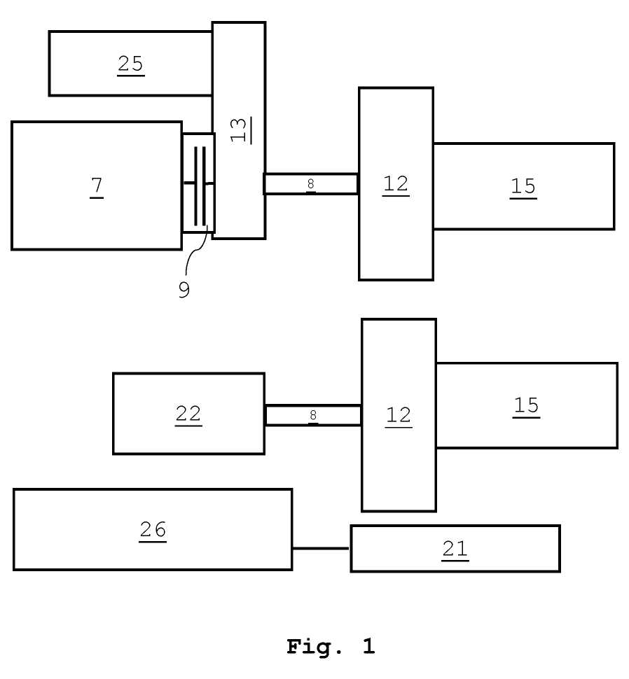

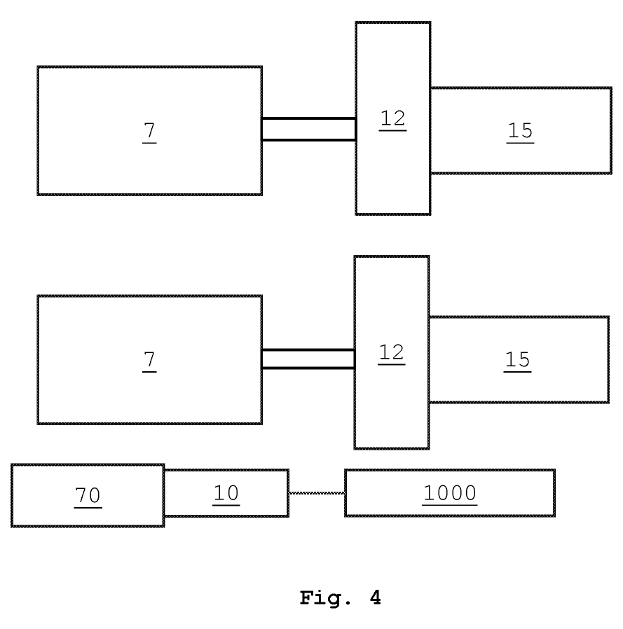

As can be seen from FIG. 1, an embodiment of a mobile crane according to the disclosure in the form of a crawler crane has, compared with the embodiment from the prior art shown in FIG. 4 with two internal combustion engines 7, only one internal combustion engine 7, one of the internal combustion engines 7 from FIG. 4 having been replaced by an electric motor 22.

On the remaining internal combustion engine 7 in the form of a diesel engine, an electric machine 25 is additionally installed with a distribution gearbox 13. The electric machine 25 can be operated as a generator and as a motor. The electric machine 25 can therefore function both as an electric motor and as an electrical generator.

The distribution gearbox 13 is connected via a cardan shaft 8 to a first pump splitter gearbox 12 and can drive the first pump splitter gearbox 12.

The electric motor 22 is connected via a cardan shaft 8 to a second pump splitter gearbox 12 and can drive the second pump splitter gearbox 12.

Each pump splitter gearbox 12 can have two pumps 15, for example in the form of hydraulic pumps.

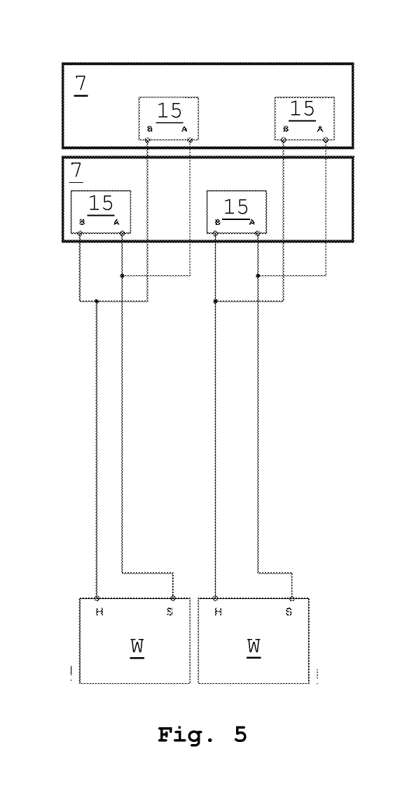

The pumps 15 can be connected to crane mechanisms, for example in the form of winches, as is shown in FIG. 5, which is explained above.

Optionally, a disconnect clutch 9 is provided between the internal combustion engine 7 and the distribution gearbox 13, so that the electric machine 25 can drive the first pump splitter gearbox 15 without the internal combustion engine 7.

Furthermore, the mobile crane has a high-voltage battery 26. The high-voltage battery 26 can be arranged in a machinery house of the mobile crane. The high-voltage battery 26 can also be referred to as a rechargeable battery or battery pack.

The high-voltage battery 26 can supply a high-voltage air-conditioning compressor 21 electrically.

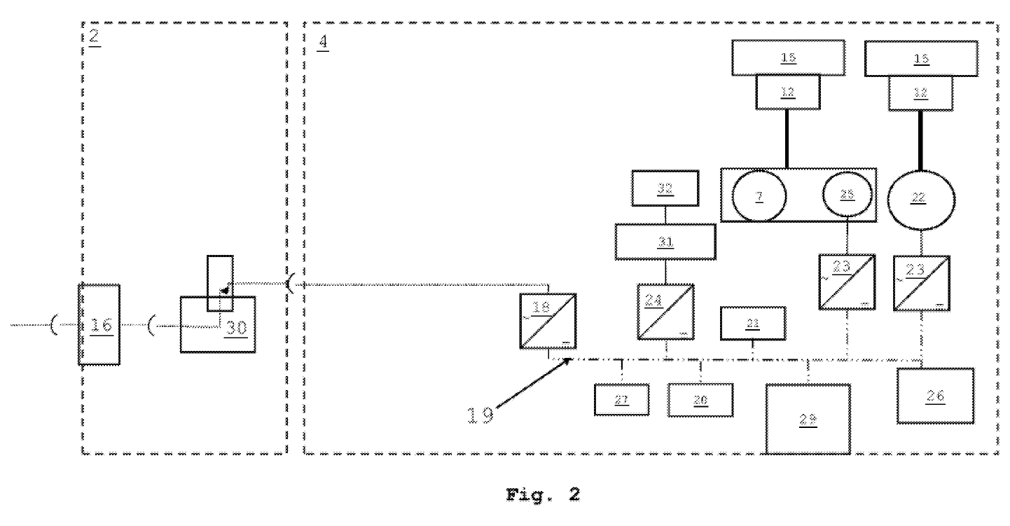

In FIG. 2, components of the undercarriage 2 and of the superstructure 4 of the embodiment of the mobile crane according to the disclosure are shown.

The components of the undercarriage 2 are shown in FIG. 2 in the dashed box provided with reference numeral 2, and the components of the superstructure 4 are shown in FIG. 2 in the dashed box provided with reference numeral 4.

The undercarriage 2 has a grid connection 16.

A slewing ring with a slip-ring transmitter 30 is arranged between undercarriage 2 and superstructure 4.

In the superstructure, the components shown in FIG. 1 are arranged with the construction shown in FIG. 1 and described above.

In the superstructure 4, an intermediate circuit 19 in the form of a direct-current intermediate circuit is present. The electrical connections of the intermediate circuit 19 are shown in FIG. 2 with dash-dotted lines.

The undercarriage 2 has an electrical alternating-current network with a grid connection 16 for supplying the electrical alternating-current network of the undercarriage 2 with electrical power from an external power grid. The superstructure 4 has an electrical alternating-current network electrically connected to the intermediate circuit 19 via a rectifier 18. The electrical connections of the alternating-current networks are shown in FIG. 2 with dotted lines.

A slewing ring with a slip-ring transmitter 30 is arranged between the undercarriage 2 and the superstructure 4, which is designed to transmit electrical power from the electrical alternating-current network of the undercarriage into the electrical alternating-current network of the superstructure.

In the superstructure 4 there are arranged, each electrically connected to the intermediate circuit 19, a heat pump 27, a high-voltage heater 20, the high-voltage air-conditioning compressor 21, an inverter 29 for providing a 230 V supply, for example an electrical supply of an air-conditioning system of the mobile crane, a DC-DC converter 24 for connecting a low-voltage on-board electrical system 31 with a vehicle battery 32 to the intermediate circuit 19, an inverter 23 for the electrical supply of the electric motor 22 and an inverter 23 for the electrical supply of the electric machine 25, and the high-voltage battery 26.

The electrical supply of the superstructure 4 takes place, for example, via three-phase current with a nominal voltage of 400 V and a maximum current of 125 A via the grid connection 16 on the undercarriage 2. The grid connection 16 can be arranged on a crawler carrier of the undercarriage 2.

Since both the high-voltage battery 26 and the electrical main consumers, in particular the electric motor 22, are all arranged in the superstructure 4, only little electrical power has to be transmitted via the slip-ring transmitter 30.

While no electrical power or only a low electrical power is called for crane operation, the high-voltage battery 26 can be charged.

If the high-voltage battery 26 were installed in the undercarriage 2 or in the crawler carrier, were positioned beside the mobile crane, or if the complete power were drawn from the power grid, the high (currently required) electrical power and thus high currents would have to be brought via the slip-ring transmitter 30. This slip-ring transmitter 30 would thereby be very large, expensive, would have to be accessible and would have to be maintained and cleaned regularly. If the routing of the power were to take place without the slip-ring transmitter 30, that is to say, for example, via a cable outside, the mobile crane would be very restricted with regard to its rotational movement of the superstructure 4. Therefore, an arrangement of all electrical main consumers in the superstructure 4 is advantageous.

The rectifier 18 can function as a charger for the high-voltage battery 26. Several rectifiers 18 may also be present in the mobile crane.

The rectifier 18 rectifies the grid voltage and feeds the intermediate circuit 19, to which the high-voltage battery 26 is connected.

All high-voltage components of the superstructure 4, that is to say in particular the high-voltage air-conditioning compressor 21, the high-voltage heater 20, the heat pump 27, the DC-DC converter 24 or DC-DC controller, the inverter 29 and the inverters 23, are supplied from the intermediate circuit 19.

In an electrical operating mode of the mobile crane, the electric machine 25 and the electric motor 22 can be supplied with electrical power or energy from the high-voltage battery 26 and via the grid connection 16 from the external power grid and can drive the pump splitter gearboxes 12 or the pumps 15.

The electric motor 22 can also be operated as a generator. In particular, the high-voltage battery 26 can be charged by means of the electric motor 22. The electric motor 22 can be used for charging purposes. This is possible in particular when lowering a load by the mobile crane. Recuperation optionally takes place when lowering the load.

In an internal-combustion-engine operating mode, the internal combustion engine 7 can, for example, when little power is required for operation of the mobile crane, supply the auxiliary loads, such as for example the high-voltage air-conditioning compressor 21, the high-voltage heater 20, the heat pump 27, the DC-DC converter 24 or DC-DC controller and the inverter 29, via the electric machine 25 and charge the high-voltage battery 26, in particular so that there is always enough power available for operation of the mobile crane.

The auxiliary loads are optionally all arranged in the superstructure 4. It is conceivable that more than half or more than three quarters of the auxiliary loads, or most of the auxiliary loads, are arranged in the superstructure.

Both in an electrical operating mode and in an internal-combustion-engine operating mode of the mobile crane, operating phases in which a lot of or the maximum power of the drive system is required are usually low relative to the total operating duration. There are thus always enough operating phases, for example operating pauses, in order to charge the high-voltage battery 26 sufficiently again.

In the case of regenerative power which arises in closed hydraulic circuits, for example when lowering a load in a winch of a hoisting gear, the high-voltage battery 26 can be charged by the electric machine 25 then driven by the first pump splitter gearbox 12, so that the power is not converted into heat but is stored as energy in the high-voltage battery 26.

By means of the high-voltage battery 26, the mobile crane can optionally be operated self-sufficiently for a certain time, that is to say without grid connection 16, which is advantageous in particular when traveling the mobile crane. In a purely electric solution without high-voltage battery 26, the cable for the external power supply would have to be dragged along.

By installing a high-voltage battery 26, the mobile crane can be operated with a relatively low grid power. In operating pauses or operating phases with little required power for operation of the mobile crane, the high-voltage battery 26 is charged with this grid power. When power demand is high, the largest portion of the power is taken from the high-voltage battery 26. Drawing a high power, that is to say for example more than 100 kW, from an external power grid via the grid connection 16 can be realized only with considerable effort at most usual deployment locations of a mobile crane. For this, for example currents of more than 125 A would be necessary. This is a further advantage of the high-voltage battery 26. It can accumulate large quantities of energy over a longer period with a low charging power and can then deliver this when required over a short time, that is to say with a high power.

Additionally, charging of the high-voltage battery 26 during mobile crane operation in idle phases or in operating pauses can also be used to load the internal combustion engine 7 in order to keep the exhaust gas temperature at a certain level and thereby enable good exhaust gas aftertreatment. If the high-voltage battery 26 is charged up to a certain state of charge, the internal combustion engine 7 is switched off and the electric motor 22 or the electric machine 25 take over the drive of the pump splitter gearboxes. This has advantages with regard to the exhaust emissions.

Furthermore, charging of the high-voltage battery 26 by the internal combustion engine 7 and the subsequent switching off of the internal combustion engine 7 can be used to reduce the duration of the noise emission, in particular so that less idling operation of the internal combustion engine 7 takes place.

Heating and air conditioning of the mobile crane can take place via high-voltage components, for example via the high-voltage air-conditioning compressor 21, the high-voltage heater 20, the heat pump 27 and/or the inverter 29, which can be supplied with electrical power from an external power grid, for example via the grid connection 16 and the rectifier 18, and/or with electrical power from the high-voltage battery 26, in particular so that no small internal combustion engine 70, no generator 10 and no auxiliary combustion heater are required. Thus, when at a standstill, the noise emissions and the exhaust emissions of the mobile crane are significantly reduced.

In an internal-combustion-engine operating mode, the charging power of the electric machine 25 is determined by the current state of charge of the high-voltage battery 26, the available grid power of the external power grid and/or the available power of the internal combustion engine 7. In this way, it is ensured that there is always enough power or energy available for the requirements of the mobile crane.

Furthermore, the operating point of the internal combustion engine 7 can be selected such that it is operated in a range of efficiency that is as optimal as possible.

The electric machine 25 mounted on the internal combustion engine 7 can be used in order to start the internal combustion engine 7. This is advantageous in particular at cold outside temperatures. The electric machine 25 already has a very high driving torque at very low rotational speeds.

At cold outside temperatures or in the case of a cold mobile crane, high drag torques occur on the hydraulic side, that is to say in the pump splitter gearbox 12, due to the cold hydraulic fluid. In order to improve the cold-start behavior even further, a clutch between distribution gearbox 13 and pump splitter gearbox 12 is conceivable.

Via the inverter 29 electrically connected to the intermediate circuit 19, a 230 V supply can be provided for other components. By this means, for example, an air-conditioning system or a socket into which external devices can be plugged can be supplied.

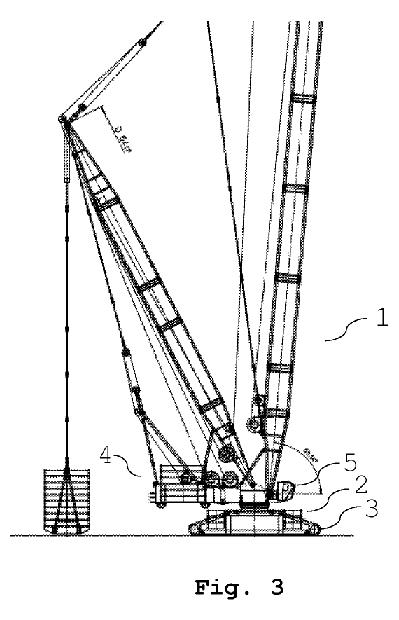

FIG. 3 shows the construction of an embodiment of a mobile crane according to the disclosure in the form of a crawler crane.

The mobile crane 1 has an undercarriage 2 with a crawler carrier 3 and a superstructure 4. The superstructure 4 has a crane cab 5.

FIGS. 4 and 5 are described above.

1. Mobile crane with a traveling undercarriage, a superstructure arranged rotatably on the undercarriage, and a drive system with a first pump splitter gearbox and a second pump splitter gearbox, wherein the drive system has an internal combustion engine, and/or an electric machine, each of which is mechanically connected to the first pump splitter gearbox, an electric motor, which is mechanically connected to the second pump splitter gearbox, and a high-voltage battery, which is electrically connected via an intermediate circuit to the electric machine and/or the electric motor.

2. Mobile crane according to claim 1, wherein the drive system has a distribution gearbox, wherein the internal combustion engine, the electric machine and the first pump splitter gearbox are mechanically connected to the distribution gearbox in such a way that the internal combustion engine can drive the electric machine and/or the first pump splitter gearbox via the distribution gearbox and/or the electric machine can drive the internal combustion engine and/or the first pump splitter gearbox via the distribution gearbox and/or the first pump splitter gearbox can drive the electric machine via the distribution gearbox.

3. Mobile crane according to claim 2, wherein the internal combustion engine is mechanically connected to the distribution gearbox via a clutch, so that the driving connection between the internal combustion engine and the distribution gearbox can be disconnected or established by the clutch.

4. Mobile crane according to claim 2, wherein the distribution gearbox is mechanically connected to the first pump splitter gearbox via a clutch, so that the driving connection between the distribution gearbox and the first pump splitter gearbox can be disconnected or established by the clutch.

5. Mobile crane according to claim 2, wherein the distribution gearbox is mechanically connected to the first pump splitter gearbox via a cardan shaft and/or that the electric motor is mechanically connected to the second pump splitter gearbox via a cardan shaft.

6. Mobile crane according to claim 1, wherein each pump splitter gearbox has two pumps, wherein a first pump of the first pump splitter gearbox and a first pump of the second pump splitter gearbox are designed and arranged for driving a crane mechanism, of the mobile crane, wherein a second pump of the first pump splitter gearbox and a second pump of the second pump splitter gearbox are designed and arranged for driving a further crane mechanism, of the mobile crane.

7. Mobile crane according to claim 1, wherein the undercarriage has an electrical network with a grid connection for supplying the electrical network of the undercarriage with electrical power from an external power grid and the superstructure has the intermediate circuit and an electrical network electrically connected to the intermediate circuit, wherein a slewing ring with a slip-ring transmitter is arranged between the undercarriage and the superstructure, which is designed to transmit electrical power from the electrical network of the undercarriage into the electrical network of the superstructure.

8. Mobile crane according to claim 1, wherein the superstructure has the high-voltage battery and the electric motor and furthermore, each electrically connected to the intermediate circuit, a heat pump, a high-voltage heater, a high-voltage air-conditioning compressor, an inverter.

9. Mobile crane according to claim 1, wherein the superstructure has all electrical main consumers of the mobile crane.

10. Mobile crane according to claim 1, wherein the mobile crane is a crawler crane.

11. Method for operating a mobile crane according to claim 1, wherein the internal combustion engine is operated and drives the first pump splitter gearbox and/or the electric machine and/or that the electric machine is operated and drives the first pump splitter gearbox and/or the internal combustion engine and/or that the first pump splitter gearbox is operated and drives the electric machine and/or that the electric motor drives the second pump splitter gearbox.

12. Method according to claim 11, wherein the high-voltage battery is charged, when the electric machine is driven by the internal combustion engine and/or by the pump splitter gearbox, by electrical power generated by the electric machine and/or that the high-voltage battery is charged by electrical power provided by a power grid.

13. Method according to claim 12, wherein charging of the high-voltage battery is ended when a defined state of charge of the high-voltage battery is reached, the internal combustion engine is switched off, and the first pump splitter gearbox is driven by the electric machine and/or the second pump splitter gearbox is driven by the electric motor.

14. Method according to claim 12, wherein the high-voltage battery is charged in operating phases with low power requirements and that the high-voltage battery is discharged in operating phases with high power requirements.

15. Method according to claim 11, wherein the internal combustion engine is started by the electric machine.
